(19) United States
(12) Patent Application Publication
(10) Pub. No.: US 2025/0035173 A1
(43) Pub. Date: Jan. 30, 2025

(54) SLIDING BEARING COMPONENT FOR AN APPLICATION DEVICE OF A DISC BRAKE FOR A VEHICLE

(71) Applicant: ZF CV Systems Europe BV, Brussels (BE)

(72) Inventor: Hans-Christian Jungmann, Gorxheimertal (DE)

(21) Appl. No.: 18/784,057

(22) Filed: Jul. 25, 2024

(30) Foreign Application Priority Data
Jul. 26, 2023 (DE) 10 2023 119 861.0

(51) Int. Cl. F16D 65/00; F16C 17/02; F16D 55/00; F16D 55/226

(52) U.S. Cl. CPC F16D 65/0068; F16C 17/02; F16D 55/226; F16C 2326/01; F16D 2055/0016

(57) ABSTRACT

A sliding bearing component (100) for an application device (250) of a disc brake (220) for a vehicle (200a), in particular a commercial vehicle (200b), has a lateral surface (110) with a cross section (115) that is in the form of a full circle in some section or sections. The sliding bearing component (100) has a limiting element (120) arranged on the lateral surface for limiting a displaceability of the sliding bearing component (100). A brake caliper (150) includes a pedestal section (155) with a recess (160) arranged to cooperate with the sliding bearing component (100). The pedestal section has a limiting element (165) arranged to receive the limiting element (120) of the sliding bearing component (100). The recess (160) is at least partly cylindrical in a section or sections and/or is defined by two planes.

### FIELD

The disclosure relates to a sliding bearing component for an application device of a disc brake for a vehicle, in particular a commercial vehicle. The disclosure also relates to a brake caliper for receiving an application device of a disc brake for a vehicle, in particular a commercial vehicle, to a disc brake for a vehicle, in particular a commercial vehicle, comprising a sliding bearing component and a brake caliper, and to a vehicle, in particular a commercial vehicle, comprising a disc brake.

### BACKGROUND

Disc brakes of this kind are known from the prior art. A disc brake of this kind has an application device. In this context, a “sliding block” as a sliding bearing component and a lever bearing can be provided as components of the application device that can be brought into effective connection with one another in each case. Sliding bearing components of this kind are known from the prior art. According to the prior art, particularly in the case of air-operated disc brakes, functional surfaces, in particular sliding surfaces, are implemented by the use of components of this kind and, in the case of a lever bearing, typically have the function of reducing sliding friction between the sliding partners of the lever bearing.

EP 3 109 499 A1 discloses a disc brake, in particular for commercial vehicles, having a brake disc, a brake shaft having a rotation axis that lies parallel to a main plane of the brake disc, a brake pad lying on the same side as the brake shaft relative to the brake disc, a pressure piece between the brake shaft and the brake pad, a first limiting device, which limits the displaceability of the pressure piece relative to the brake disc in a direction parallel to the rotation axis of the brake shaft to a predefined first extent, and a second limiting device, which limits the displaceability of the brake shaft relative to the brake disc in a direction parallel to the rotation axis of the brake shaft to a predefined second extent, wherein, upon actuation, the brake shaft presses the pressure piece and therefore the brake pad against the brake disc. The second limiting device has a first stop on the pressure piece and a second stop on the brake shaft, said second stop interacting with the first stop so as to limit the displaceability. In principle, the support of the brake shaft on the brake caliper can be configured in any desired manner. In this context, support can be provided by way of a sliding block. By appropriate sliding, such a sliding block may avoid jamming of the elements participating in the application of the brake. Furthermore, it is possible to provide a third limiting device, which limits the displaceability of the sliding block relative to the brake disc in at least one direction parallel to the main plane of the brake disc to a predefined third extent. Such a limiting device can be helpful especially during the assembly of the brake, namely, for example, as a means of preventing the loss of the sliding block. In this context, provision may be made for the third limiting device to have a projection which projects into a recess in the assembled state.

EP 3 499 071 A1 discloses an application device for a disc brake, in particular for a sliding caliper disc brake, for brake disc application. The disc brake has at least one brake caliper for receiving the application device and brake pads for application to the brake disc. The application device furthermore comprises an application lever having at least one application lever foot. In the direction of the side facing the brake pad or the side facing away from the brake pad, the application lever foot has a recess for receiving a bearing shell. The application lever is arranged within the brake caliper of the disc brake and is supported, on the side facing away from the brake pad, on an inner wall of the brake caliper via two sliding blocks.

The fastening of the sliding block as a sliding bearing component is reliable. However, the production of the sliding block and/or of the inner wall of the brake caliper on which the sliding block is supported is relatively complex on account of the geometry of the sliding block: to be specific, the sliding block has a cross section which is substantially, that is to say without consideration of the limiting device, in the form of a circular segment. Thus, the sliding block has a cross section which is bounded by a curved arc and a planar chord. The production of a sliding bearing component of this kind thus has a cost efficiency which is in need of improvement.

### SUMMARY

The disclosure is based on the object of enriching the prior art and at least partially improving the abovementioned aspects. In particular, the disclosure achieves the object of enabling the provision of an alternative sliding bearing component that allows more efficient production of said component and/or of a friction partner.

According to one aspect of the disclosure, a sliding bearing component for an application device of a disc brake for a vehicle, in particular a commercial vehicle, is provided, wherein the sliding bearing component has a lateral surface with a cross section that is in the form of a full circle in some section or sections, and the sliding bearing component has a limiting element on a sliding-bearing component side (of a limiting interface) for limiting a displaceability of the sliding bearing component, said limiting element being arranged on the lateral surface.

Here, it has been recognized that the production of the sliding bearing component can be more efficient if the lateral surface has a cross section that is in the form of a full circle in some section or sections. The cross section in the form of a full circle or the shape of the sliding bearing component, which is thus cylindrical in some section or sections, makes possible significantly more efficient production of the sliding bearing component.

To enable movement of the sliding bearing component to be limited and/or avoided as reliably as in the prior art, the sliding bearing component has the limiting element on the sliding-bearing component side (of the limiting interface) for limiting a displaceability of the sliding bearing component. For this purpose, the limiting element of the sliding bearing component can be brought into effective connection with a limiting element of the brake caliper on a brake-caliper side (of the limiting interface).

As an option, the limiting element of the sliding-bearing component has a cross section that is in the form of a full circle in some section or sections. This allows efficient production of the limiting element. The limiting element can project radially from the lateral surface to enable it to be brought into effective connection with the limiting element of the brake-caliper. The limiting element can be a bolt projecting from the lateral surface.

As an option, the sliding bearing component has a cylindrical body, and the limiting element of the sliding-bearing component is welded to the body and/or connected nonpositively to the body. A secure and reliable connection is thus possible between the body and the limiting element of the sliding-bearing component. Welding enables the limiting element of the sliding-bearing component to be arranged on the lateral surface. For nonpositive connection, the body can have an opening, into which the limiting element of the sliding-bearing component is at least partially pressed and thus fixed. After pressing in, a clamping force that allows reliable fixing of the limiting element of the sliding-bearing component in the opening can act between the limiting element of the sliding-bearing component and the opening in the body.

As an option, the sliding bearing component has a longitudinal axis, and the sliding bearing component has the cross section in the form of a full circle in a section defined along the longitudinal axis. In this case, it is possible, in particular, for said section to be arranged outside the limiting element of the sliding-bearing component when viewed in the direction of the longitudinal axis. The sliding bearing component is thus cylindrical in said section. Outside said section, the shape defined by the limiting element of the sliding-bearing component can deviate from a cylindrical shape.

According to one aspect of the disclosure, a brake caliper for receiving an application device of a disc brake for a vehicle, in particular a commercial vehicle, is provided, wherein the brake caliper has a pedestal section for the arrangement of the sliding bearing component, the pedestal section has a recess, the recess is configured to receive the lateral surface of the sliding bearing component, and the pedestal section has a limiting element of the brake caliper on a brake-caliper side (of the limiting interface) for limiting a displaceability of the sliding bearing component, wherein the limiting element of the brake-caliper is configured to be brought into effective connection with the limiting element of the sliding-bearing component in order to limit the displaceability of the sliding bearing component relative to the pedestal section, wherein the recess is cylindrical in some section or sections and/or is defined by two planes.

The brake caliper comprising the pedestal section with the recess allows effective support of the sliding bearing component. In this case, the recess can be cylindrical in some section or sections and can have a shape matched to the lateral surface of the body of the sliding bearing component. Alternatively or in addition, the recess may also be defined by two planes, in particular mutually parallel planes. The planes then define a U-shaped recess or pocket in which the sliding bearing component can be at least partially arranged.

As an option, the limiting element of the brake-caliper is a pocket, which is in the form of a full circle in some section or sections. It is thereby possible to bring the limiting element of the sliding-bearing component, in particular one with a cross section in the form of a full circle, effectively and reliably into effective connection with the limiting element of the brake-caliper in order to reliably reduce and/or avoid a movement of the sliding bearing component.

As an option, the recess has a longitudinal axis along which the pedestal section extends. This enables the sliding bearing component to be arranged and aligned in a well-defined and reliable manner on the pedestal section by way of the lateral surface.

According to one aspect of the disclosure, a disc brake for a vehicle, in particular a commercial vehicle, comprising the sliding bearing component described above and the brake caliper described above is provided. The disc brake or sliding bearing component and/or the brake caliper optionally comprise/comprises one or more of the features described above in order to bring about an associated technical effect.

According to one aspect of the disclosure, a vehicle, in particular a commercial vehicle, comprising the disc brake described above is provided. The disc brake of the vehicle, in particular the commercial vehicle, optionally comprises one or more of the features described above in order to bring about an associated technical effect.

### BRIEF DESCRIPTION OF THE DRAWINGS

Further features of the disclosure and the technical effects thereof will become apparent from the figures and the description of the embodiments shown in the figures. In this case:

FIG. 1 shows a schematic illustration of a vehicle, in particular a commercial vehicle, according to one aspect of the disclosure;

FIG. 2 shows a cross section through a detail of a disc brake, said detail showing an application device;

FIG. 3 shows a perspective view of a detail of a brake caliper;

FIG. 4 shows a perspective view of a sliding bearing component;

FIG. 5 shows a cross section through a detail of a disc brake according to one aspect of the disclosure, said detail showing an application device;

FIG. 6 shows a perspective view of a detail of a brake caliper according to one aspect of the disclosure;

FIG. 7 shows a perspective view of a sliding bearing component according to one aspect of the disclosure; and

FIG. 8 shows a side view of a sliding bearing component according to one aspect of the disclosure.

### DETAILED DESCRIPTION

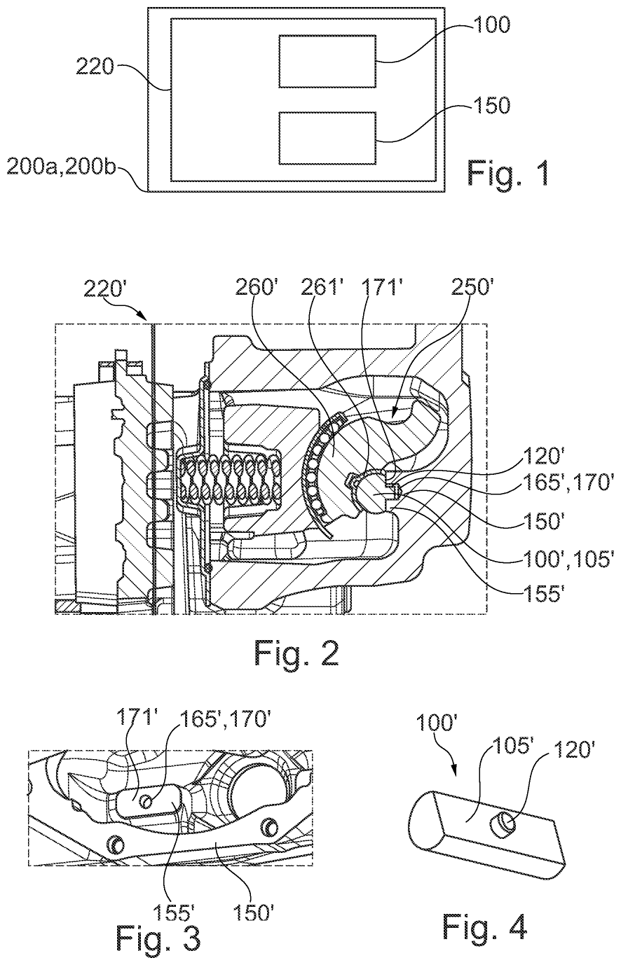

FIG. 1 shows a schematic illustration of a vehicle 200a, in particular a commercial vehicle 200b, according to one aspect of the disclosure. The vehicle 200a, in particular commercial vehicle 200b, is referred to below as vehicle 200a, 200b. The vehicle 200a, 200b is a land vehicle, e.g. a tractor and/or a trailer of an articulated vehicle and/or a bus.

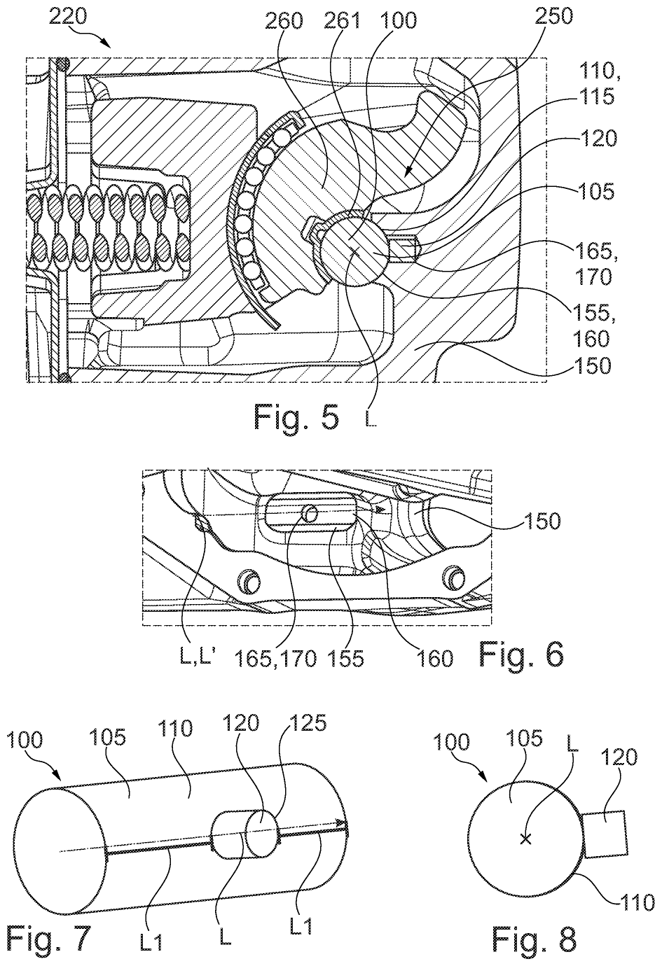

The vehicle 200a, 200b comprises a disc brake 220. The disc brake 220 can be actuated pneumatically and/or electropneumatically and is configured to decelerate a movement of the vehicle 200a, 200b or to brake the vehicle 200a, 200b. For this purpose, the disc brake 220 can bring about a braking torque on one or more wheels (not shown) of the vehicle 200a, 200b. To achieve this, the disc brake 220 comprises an application device 250 (see FIGS. 2 and 5) for applying brake pads to a brake disc as friction partners that can be brought into effective connection in order to decelerate the vehicle 200a, 200b. For this purpose, the disc brake 220 comprises a sliding bearing component 100 and a brake caliper 150.

In particular, the brake caliper 150 can be designed as a floating and/or sliding caliper and can thus be arranged in a manner supported to enable it to move relative to the brake disc. In another embodiment, the brake caliper 150 can be designed as a fixed caliper and arranged in a fixed location relative to the brake disc.

A disc brake 220′, a sliding bearing component 100′ and a brake caliper 150′ are furthermore described with reference to FIGS. 2 to 4.

A disc brake 220, a sliding bearing component 100 and a brake caliper 150, each according to one aspect of the disclosure, are furthermore described with reference to FIGS. 5 to 8.

FIG. 2 shows a cross section through a detail of a disc brake 220′, said detail showing an application device 250.

The application device 250′ includes a lever (not indicated) having a lever foot 260′. A bearing shell 261′ is arranged or secured on the lever foot 260.

The application device 250′ or disc brake 220′ includes a sliding bearing component 100′ designed as a sliding block. The sliding bearing component 100′ and the lever foot 260′ or the bearing shell 261′ are configured to be in effective connection with one another in order to allow rotatable mounting of the lever foot 260′ and thus allow rotation of the lever foot 260′ around the sliding bearing component 100′.

The sliding bearing component 100′ includes a body 105′, which can be brought into mechanical contact with the bearing shell 261′, and a limiting element 120′ on the sliding-bearing component side (of a limiting interface) for limiting a displaceability of the sliding bearing component 100′. The sliding bearing component 100′ has a body 105′ with a cross section in the form of a partial circle, as can be seen in the cross section in FIG. 2, and thus has a contour in the form of a partial cylinder with a surface that is cylindrical in one section and flat in one section.

The disc brake 220′ includes a brake caliper 150′ for receiving the application device 250′. For this purpose, the brake caliper 150′ has a pedestal section 155′ for the arrangement of the sliding bearing component 100′. The sliding bearing component 100′ and the pedestal section 155′ are configured to be brought into effective connection with one another in order to support the sliding bearing component 100′ on the pedestal section 155′. Accordingly, the pedestal section 155′ is defined by a plane 171′ on which the sliding bearing component 100′ can be supported, in particular, by way of the surface of the sliding bearing component 100′, said surface being flat in some section or sections.

The pedestal section 155′ has a limiting element 165′ on the brake-caliper side (of the limiting interface) for limiting a displaceability of the sliding bearing component 100′. The limiting element 165′ of the brake-caliper is a depression or pocket 170′ within the pedestal section 155′. In this case, the limiting element 165′ of the brake-caliper is configured to be brought into effective connection with the limiting element 120′ of the sliding-bearing component in order to limit the displaceability of the sliding bearing component 100′ relative to the pedestal section 155′. The limiting element 120′ of the sliding-bearing component is a pin, which can be inserted into the pocket 170′ in order to hold the sliding bearing component 100′.

FIG. 3 shows a perspective view of a detail of brake caliper 150′. FIG. 3 is described with reference to FIG. 2. FIG. 3 illustrates, in particular, the pedestal section 155′, which is defined by the plane 171′ and has the pocket 170′.

FIG. 4 shows a perspective view of sliding bearing component 100′. FIG. 4 is described with reference to FIGS. 2 and 3. FIG. 4 illustrates, in particular, the body 105′ of the sliding bearing component 100′ with the cross section in the form of a partial circle and, in particular, the surface of the sliding bearing component 100′, said surface being flat in some section or sections.

FIG. 5 shows a cross section through a detail of a disc brake 220 according to one aspect of the disclosure, said detail showing an application device 250. A disc brake 220 of this kind is described with reference to FIG. 1. FIG. 5 is described with reference to FIG. 1. FIG. 5 is furthermore described with reference to FIGS. 2 to 4, with the differences of the embodiment shown in FIGS. 2 to 4 and of the embodiment shown in FIG. 5 being described below.

The sliding bearing component 100 of FIG. 5 has a lateral surface 110 with a cross section 115 that is in the form of a full circle in some section or sections. In the cross section shown in FIG. 5, the cross section 155 is therefore in the form of a full circle, i.e. circular, apart from the limiting element 120 of the sliding-bearing component. Apart from the limiting element 120 of the sliding-bearing component, therefore, the sliding bearing component 100 is cylindrical.

The sliding bearing component 100 has the limiting element 120 on the sliding-bearing component side (of the limiting interface) for limiting a displaceability of the sliding bearing component 100, said limiting element being arranged on the lateral surface 110. The limiting element 120 of the sliding-bearing component has a cross section 125 that is in the form of a full circle in some section or sections (see also FIG. 7). The limiting element 120 is a pin or a bolt, which projects from the lateral surface 110.

The sliding bearing component 100 has the cylindrical body 105, and the limiting element 120 of the sliding-bearing component is welded to the body 105 and/or connected nonpositively to the body 105. For example, the limiting element 120 of the sliding-bearing component is a pin or bolt pressed into an opening of the sliding bearing component 100.

The sliding bearing component 100 has a longitudinal axis L. In the illustration shown in FIG. 5, the longitudinal axis L projects into the plane of the image, as indicated schematically by a cross.

The pedestal section 155 has a recess 160. The recess 160 is configured to receive the lateral surface 110 of the sliding bearing component 100. The lateral surface 110 thus projects into the pedestal section 155. The recess 160 is cylindrical in some section or sections (see also FIG. 6) and/or is defined by two planes.

The limiting element 165 of the brake-caliper is a pocket 170 that is in the form of a full circle in some section or sections. In the assembled state as shown in FIG. 5, the limiting element 120 of the sliding-bearing component is arranged at least partially in the limiting element 165 of the brake-caliper.

FIG. 6 shows a perspective view of a detail of a brake caliper 150 according to one aspect of the disclosure. FIG. 6 shows the brake caliper 150 described with reference to FIG. 5. FIG. 6 is described with reference to FIGS. 1 to 5.

The recess 160 has a longitudinal axis L′. The pedestal section 155 extends along the longitudinal axis L′ of the recess 160. In the assembled state, the longitudinal axis L′ of the recess 160 and the longitudinal axis L of the sliding bearing component 100 coincide.

FIG. 7 shows a perspective view of a sliding bearing component 100 according to one aspect of the disclosure. FIG. 7 shows the sliding bearing component 100 described with reference to FIG. 5. FIG. 7 is described with reference to FIGS. 1 to 6.

As shown in FIG. 7, the sliding bearing component 100 has the cross section 115 in the form of a full circle in an axial section L1 defined along the longitudinal axis L. The body 105 of the sliding bearing component 100 is thus substantially cylindrical in the longitudinal direction L. Aside from the limiting element 120 of the sliding-bearing component, the sliding bearing component 100 is cylindrical.

FIG. 8 shows a side view of a sliding bearing component 100 according to one aspect of the disclosure. FIG. 8 shows the sliding bearing component 100 described with reference to FIG. 5. FIG. 8 further illustrates the features of the sliding bearing component 100 which have been described with reference to FIG. 5.

### REFERENCE SIGNS (PART OF THE DESCRIPTION)

100 sliding bearing component
105 body
110 lateral surface
115 cross section
120 limiting element of the sliding-bearing component
125 cross section
150 brake caliper
155 pedestal section
160 recess
165 limiting element of the brake-caliper
170 pocket
200a vehicle
200b commercial vehicle
220 disc brake
250 application device
260 lever foot
261 bearing shell
L longitudinal axis
L′ longitudinal axis
L1 section
100′ sliding bearing component
105′ body
120′ limiting element of the sliding-bearing component
150′ brake caliper
155′ pedestal section
165 limiting element of the brake-caliper
170′ pocket
171′ plane
220′ disc brake
250′ application device
260′ lever foot
261′ bearing shell

What is claimed is:

1. A sliding bearing component (100) for an application device (250) of a disc brake (220) for a vehicle (200a, 200b), the sliding bearing component (100) comprising:
a lateral surface (110) with a cross section (115) that is in the form of a full circle in a section or sections of the lateral surface (100), and
a limiting element (120) of the sliding bearing component (100) for limiting a displaceability of the sliding bearing component (100), wherein the limiting element is arranged on the lateral surface (110).

2. The sliding bearing component (100) as claimed in claim 1, wherein the limiting element (120) of the sliding-bearing component (100) has a cross section (125) that is in the form of a full circle in a section or sections of the limiting element (120).

3. The sliding bearing component (100) as claimed in claim 1, wherein
the sliding bearing component (100) has a cylindrical body (105), and
the limiting element (120) of the sliding-bearing component (110) is welded to the cylindrical body (105) and/or connected nonpositively to the cylindrical body (105).

4. The sliding bearing component (100) as claimed in claim 1, wherein
the sliding bearing component (100) has a longitudinal axis (L), and
the sliding bearing component (100) has the cross section (115) in the form of a full circle in an a section (L1) defined along the longitudinal axis (L).

5. A brake caliper (150) for receiving an application device (250) of a disc brake (220) for a vehicle (200a), the brake caliper comprising:
a pedestal section (155) for the arrangement of a sliding bearing component (100),
wherein the pedestal section (155) has a recess (160),
wherein the recess (160) is configured to receive a lateral surface (110) of a sliding bearing component (100),
wherein the pedestal section (155) has a limiting element (165) of the brake caliper for limiting a displaceability of the sliding bearing component (100), and
wherein the limiting element (165) of the brake caliper is configured to be brought into effective connection with a limiting element (120) of the sliding bearing component (100) in order to limit the displaceability of the sliding bearing component (100) relative to the pedestal section (155),
wherein the recess (160) is at least partially cylindrical in a section or sections and/or is defined by two planes.

6. The brake caliper (150) as claimed in claim 5, wherein the limiting element (165) of the brake caliper has a pocket (170), which is in the form of a full circle in a section or sections.

7. The brake caliper (150) as claimed in claim 5, wherein the recess (160) has a longitudinal axis (L) along which the pedestal section (155) extends.

8. A disc brake (220) for a vehicle (200a, 200b) comprising the sliding bearing component (100) as claimed in claim 1.

9. A disc brake (220) for a vehicle (200a, 200b), comprising the brake caliper (150) as claimed in claim 5.

10. A vehicle (200a, 200b), comprising a disc brake (220) as claimed in claim 8.

11. A vehicle (200a, 200b) comprising a disc brake (220) as claimed in claim 9.

12. A disc brake (220) for a vehicle (200a, 200b) comprising:
a sliding bearing component (100) for an application device (250) of the disc brake (220), the sliding bearing component (100) comprising:
a lateral surface (110) with a cross section (115) that is in the form of a full circle in a section or sections of the lateral surface (100), and
a limiting element (120) of the sliding bearing component (100) for limiting a displaceability of the sliding bearing component (100), wherein the limiting element is arranged on the lateral surface (110);
a brake caliper (150) for receiving the application device (250) of the disc brake (220), the brake caliper comprising:
a pedestal section (155) for the arrangement of the sliding bearing component (100),
wherein the pedestal section (155) has a recess (160),
wherein the recess (160) is configured to receive the lateral surface (110) of the sliding bearing component (100),
wherein the pedestal section (155) has a limiting element (165) of the brake caliper for limiting a displaceability of the sliding bearing component (100), and
wherein the limiting element (165) of the brake caliper is connected with the limiting element (120) of the sliding bearing component in order to limit the displaceability of the sliding bearing component (100) relative to the pedestal section (155),
wherein the recess (160) is at least partly cylindrical in a section or sections and/or is defined by two planes.

13. The disc brake according to claim 12, wherein the sliding bearing component (100) is at least partially received in the recess (160) and is supported on the recess (160).

14. The disc brake according to claim 12, wherein the lateral surface (110) of the sliding bearing component (100) is convex, and the recess (160) is concave and receives the lateral surface (110) of the sliding bearing component (100).

15. The disc brake according to claim 12, wherein the sliding bearing component has a longitudinal axis (L) and the recess (160) has a longitudinal axis (L′), wherein the longitudinal axis (L′) of the recess (160) and the longitudinal axis (L) of the sliding bearing component (100) coincide.

16. The disc brake according to claim 12, wherein the limiting element (120) of the sliding bearing element projects radially outward from the lateral surface (110) and the limiting element (165) of the brake caliper is a pocket (170) that extends radially inward into the pedestal section (155).

17. The disc brake according to claim 16, wherein the limiting element (120) of the sliding bearing component (100) and the limiting element (165) of the pedestal section are cylindrical in profile.

18. A vehicle (200a, 200b) comprising a disc brake (220) as claimed in claim 12.
